(19) United States
(12) Patent Application Publication
(10) Pub. No.: US 2004/0244907 A1
(43) Pub. Date: Dec. 9, 2004

(54) Methods of making printed labels and labeling articles

(76) Inventors: Scott W. Huffer, Hartsville, SC (US); Jeffrey M. Schuetz, Florence, SC (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/456,341

(22) Filed: Jun. 6, 2003

(51) Int. Cl. B41M 1/00; B32B 31/00

(52) U.S. Cl. 156/277

(57) ABSTRACT

A method of producing and using a preprinted label with pressure sensitive adhesive and an electron beam cured release coating is described. The label is formed from a web on which surface printing and the release coating are provided on one side. The pressure sensitive adhesive is pattern applied to the opposite side of the web. One or more processing additives in the release coating include a functional group which reacts into the electron beam cured network during cross-linking. The reacted-in additives are non-migratory and do not bloom out of the coating or adversely affect the PSA when the web is wound up in a roll.

### FIELD OF THE INVENTION

The present invention relates to the field of labels and, more particularly, to the field of preprinted labels. Although preprinted labels have a wide range of use, the present invention is particularly well suited for use in the field of bottle and can labeling.

### BACKGROUND OF THE INVENTION

Preprinted labels serve numerous functions with regard to the sale of goods. Labels provide decorative indicia to catch the eye of a consumer, identify the nature of the product, educate the consumer as to nutritional information of consumables, and impart good will to the product by identifying its source. Labels are especially important in the sale of beverages, wherein the unlabeled products of competitors may be visually indistinguishable.

Labels for bottles are produced in various sizes and types. A common label is rectangular in shape and is affixed to the bottle using a permanent hot melt adhesive. Other bottle labels may be formed in a sleeve shape, wrapped around the body of the bottle, and heat shrunk in order to cling to the bottle. Still other labels may be wrapped around the bottle, the opposite ends of the label coming into contact and becoming adhered to each other through the use of an adhesive or a heat seal. One of the most common methods of affixing labels to bottles remains the use of hot melt adhesive at the bottler's plant.

Application of adhesive is conventionally left to the bottler in large scale operations because the labels are processed using automated equipment, which requires the use of processing additives, such as slip agents, in the label web to prevent jamming, ripping and other undesirable conditions in the processing equipment. During storage and shipment from the label manufacturer to the producer or packager of articles in need of the labels, such additives tend to migrate or bloom out of laminate layers where they are needed. The migratory additives can poison any adhesives that have been pre-applied to the labels. When a web of labels is formed in a roll for storage and shipment, the migratory additives can cause the adhesive to block. Thus, application of adhesive to a web of labels prior to shipment to a bottler has been impractical, forcing the bottler to apply hot melt adhesive at the bottler's facility.

However, the use of hot melt adhesive requires that the bottler maintain and operate expensive equipment for applying the hot melt adhesive to the back of the label immediately prior to affixing it to the bottle. In order to perform the operation effectively, precise registration between the label feed and hot melt applicator is required. When the proper registration is not achieved, several labels can be wasted or poorly labeled bottles can be produced. In addition, the cost of the hot melt adhesive is of concern to the bottler.

Another consideration in labeling bottles is the appearance of the label, which can enhance or detract from a producer's image. A beverage producer may spend substantial sums of money every year advertising its product line. Money is spent on conventional advertisements, such as television commercials, written ads in newspapers and direct mail. Money is also spent sponsoring events, on local, national and even global scales, in order to establish and maintain good will. Beverage producers go to great lengths to project an image of quality and good will because consumers often make purchasing decisions based on these intangible factors, especially when faced with the difficult choice between two beverages which some might consider very similar.

Advertising of a company's product and the projection of good will is only part of the battle to win a customer's purchase. The product itself must appear attractive, clean and well cared for before it reaches the customer. A product which appears to a consumer to be of inferior quality or which looks like it has been abused before reaching the customer may not be purchased despite all the promotional efforts of the producer. A label on a beverage bottle, for instance, does not speak well for the product contained therein if it is smeared, torn or otherwise damaged. Thus, the integrity of preprinted labels, especially the printed ink, must be protected from damage, often caused by smearing through contact with solvents, as well as physical harms such as scraping or scratching.

The conventional approach to protecting the ink of a label involves laminating a clear layer of plastic film on top of the ink, thereby sandwiching the ink between a first polymer base film and the second film. A white or opaque oriented polypropylene (“OPP”) film is generally used to form the base layer. The white OPP film may be surface printed before an adhesive is applied. A clear plastic film, generally OPP or polyethylene terephthalate (“PET”) is laminated on top of the ink. Alternatively, the top clear film might be reverse printed. A conventional label employing this approach may, therefore, have a structure: (1) a white opaque base film of OPP; (2) ink; (3) adhesive; and (4) clear OPP. Although this approach has proven to be fairly effective, the multi-layer construction is expensive because it requires both an adhesive layer and an outer OPP or PET film. Further, a common method of manufacturing the label involves a pass across a printing press and a pass across a laminator, requiring longer processing times and greater expense than a one-pass process. Still more expense is incurred by the label manufacturer in storing the two-ply laminate because the adhesive requires a long period of time to cure. Moreover, as noted above, additional cost will be incurred later by the bottler because the conventional label must be provided with hot melt adhesive prior to application.

Attempts to improve labels utilize ultra violet (“UV”) energy cured inks to reduce smearing by contact with solvents. The UV cured inks do not dissolve in most solvents, thereby preventing smearing. However, the UV curable inks can be expensive. Moreover, UV curable ink inventories require special storage, complicating the manufacturing process. In the end, the UV curable ink approach affords little protection against mechanical damage, such as scratches or scrapes, due to unreacted residual photoinitiator present in the cured coating.

Other known attempts to improve labels involve the application of an energy cured coating to protect a conventional ink layer. However, known coatings do not have the appearance characteristics of laminates, such as clarity and gloss, and can suffer from additional drawbacks. U.S. Pat. No. 5,945,183 to Johnson describes a label with a UV curable coating. However, UV curing can be expensive and may not produce the attractive appearance required by the producer. UV curing requires the use of expensive photoinitiators which remain present in the label in a residual amount after cross-linking. The initiators can adversely effect the appearance of the coating, such as the transparency and gloss. In addition, initiators can migrate and cause unpleasant odors, as well as other problems encountered by those skilled in the art. Moreover, UV cured coatings are cross-linked at relatively low energy, leaving some monomer unreacted, further adversely affecting the appearance and properties of the coating.

Others have proposed a label formed from an oriented polypropylene substrate that is surface printed and coated with an electron beam (“EB”) cured coating to protect the ink. Although the proposed EB cured coating potentially reduces the cost of producing labels, it does not address the appearance problems known to coatings or solve the need for the article producer to apply hot melt adhesive to the label prior to applying it to an article.

### SUMMARY OF THE INVENTION

The invention is related to a method of labeling articles by producing an improved label, shipping the label to a producer or packager of articles, and applying the labels to articles without the need for hot melt adhesive application at the producer's or packager's facility. The method of the present invention is considered ideal for use in the labeling of beverage bottles, to which frequent reference is made herein.

The label produced and used in the method of the present invention includes a substrate, an electron beam cured release coating with non-migratory processing additives on a first side of the substrate, and a pressure sensitive adhesive on the second side of the substrate.

The method of the present invention involves printing and coating a first side of a substrate with an electron beam (“EB”) curable coating and curing the coating with EB radiation. A pressure sensitive adhesive (“PSA”) is then pattern applied on the second side of the substrate. With the PSA and EB cured coating on opposite sides of the substrate, the substrate is then wound up in a roll, in which the EB cured coating functions as a release layer for the PSA when the roll is unwound.

The EB curable coating applied to the first side of the substrate includes a blend of oligomers, monomers and functional slip agents, as well as other desired processing additives. When the coating is EB cured, the monomers, oligomers and functional slip agents become ionized and cross-link, thereby forming a stable network having non-migratory slip agents. Thus, the slip agents do not migrate or bloom out of the coating when the film is wound up in the roll.

The roll of preprinted labels, with PSA in place, can be economically shipped to a producer or packager of articles in need of labeling. Once at the producer's or packager's facility, the method is completed by unwinding at least a portion of the roll, cutting the coated substrate into the shape of a label, and applying the label to the article by affixing the PSA to the outside surface of the article using pressure. Thus, the labels may be applied to articles without the use of hot melt adhesive at the producer's facility.

### BRIEF DESCRIPTION OF THE DRAWING

For the purpose of illustrating the invention, there are shown in the drawings forms which are presently preferred; it being understood, that this invention is not limited to the precise arrangements and instrumentalities shown.

FIG. 1 is a schematic representation showing the preparation and application of a web of labels according to the present invention.

FIG. 2 is a plan view of a web produced in accordance with the present invention, prior to being slit.

FIG. 3 is a schematic cross sectional view of the web of FIG. 2 as seen through line 3-3.

### DETAILED DESCRIPTION OF THE DRAWING

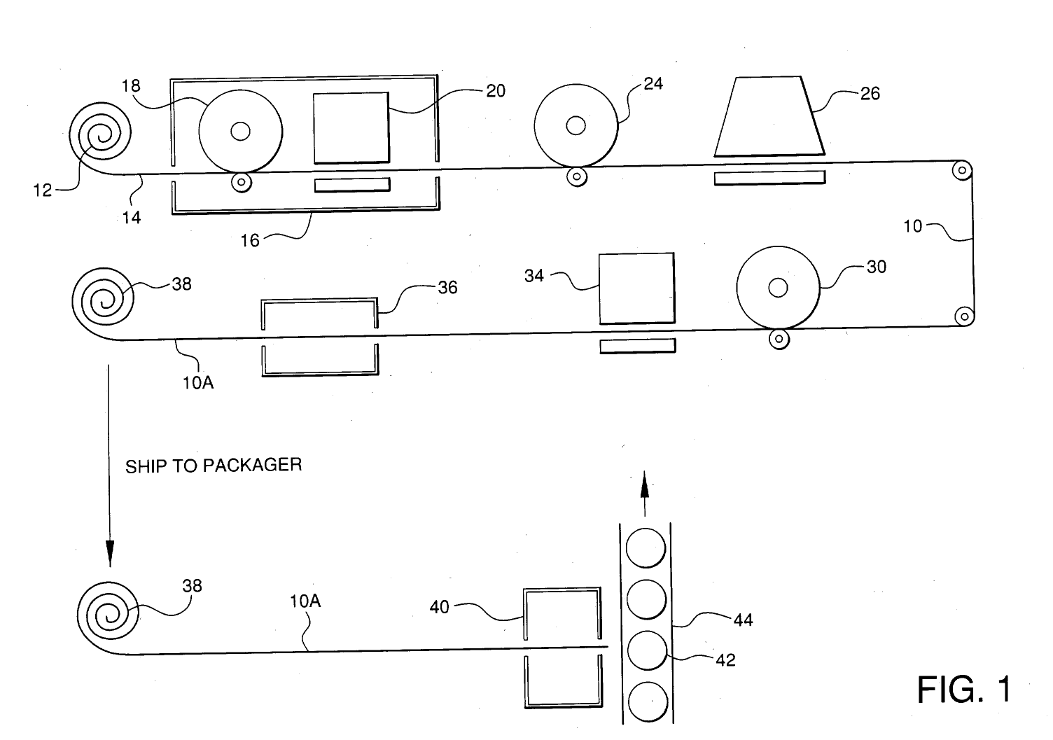

With reference to FIG. 1, there is schematically shown the production and application of a web of labels, generally identified by the numeral 10. The web 10 is formed into rolls of preprinted labels suitable for use in labeling articles for sale in the stream of commerce. The rolls of labels are shipped to a producer or packager of such articles, where the rolls can be unwound and applied to articles without the use of hot melt adhesive at the producer's facility. The terms producer or packager of articles are used herein to indicate the person or entity who will place labels from a web of labels onto articles. Such labels are ideal for use on bottles, such as plastic bottles generally formed from polyethylene terephthalate (“PET”).

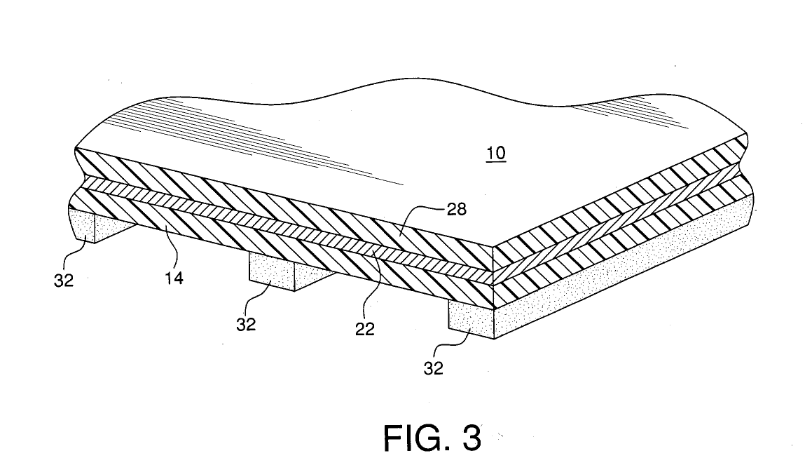

A supply roll 12 of a suitable substrate 14, preferably a polymer film such as a 1.2 mil opaque white oriented polypropylene (“OPP”), is unwound and passed through one or more printing stations 16, each of which includes an ink application cylinder 18 and a dryer 20. Only one printing station 16 is shown in FIG. 1. However, it should be understood that the use of three or more printing stations 16 is contemplated, depending on the number of colors to be printed. The film is preferably surface printed with any acceptable printing technique, such as by flexo graphic or roto gravure printing units, to provide a printed image 22 (FIG. 3). Alternatively, a clear film (not shown), such as clear OPP, can be reverse printed and laminated to the substrate 14, thereby sandwiching the ink layer between the films. The film is optionally treated by known techniques such as corona discharge before ink application. Alternative means for printing on a thermoplastic web are also known and can be used in connection with the present invention. The printing may contain indicia to identify the source of the goods on which labels cut from the web 10 are to be affixed. The printed image 22 may also contain nutritional information or other facts relevant to a potential purchaser, such as price. Ideally, the printed image 22 is eye catching and attractive to the consumer, thereby enticing a sale of the goods to which the labels are ultimately affixed.

Once the film has been printed, it is passed through an EB curable coating application station 24, where an electron beam curable coating is coated onto a first side of the film, thereby sandwiching the ink layer between the EB curable coating and the substrate 14. Most any conventional coating unit, such as flexo or gravure units, may be used to apply the EB curable coating. The EB curable coating is preferably a combination of oligomers, monomers, functional slip agents and other processing additives. The preferred oligomer is an epoxy acrylate. The preferred monomer is an acrylate. The monomers act as diluents, used to reduce the viscosity of the coating for application purposes. The concentration of monomer is adjustable to provide a wide range of viscosity, such that many conventional coating systems may be employed to apply the EB curable coating. The blend ratio of oligomer and monomer also controls physical properties and adhesion of the coating.

The slip agents in the coating, which improve the coefficient of friction, include a functional group having a double bond, which will break under an ionizing beam of accelerated electrons and react with the oligomer to become fixed or “reacted-in” during cross-linking of the EB curable coating. Such functional groups are preferably alkenes, such as acrylates. However, other known functional groups may also be suitable. The exact chemical structure of the slip additives will depend largely on the oligomer component of the coating. Given the disclosure of the present application, suitable coatings having slip agents with such a functional group can be formulated by those skilled in the art of EB curable coatings. The critical requirement of the functional group is that it contains a carbon double bond, which will allow the slip agents to chemically react into the oligomer/monomer network and become fixed in the cross-linking process. Thus, the slip agents are not susceptible to the problems associated with slip agent migration.

Various additional additives, the exact nature of which will depend on the specifications of the label desired, may also be included in the EB curable coating formulation. It is well known to provide additives, such as defoamers and wetting agents to polymer films to improve, for example, gloss and processing qualities. However, the additional additives of the present invention, can also include functional groups so as to react into the oligomer/monomer network during EB curing. The stability of the electron beam curable coating and its additives therefore allows for excellent control of the gloss and slip qualities of the label, allowing a manufacturer to create labels according to demanding specifications.

The preferred EB curable coating to be used in the present invention is sold by Sovereign Chemical and identified by the formulation number EB 1012 F. It has been found that the EB 1012 F coating, when applied at a coat weight of two pounds per ream and cured using the method described below, has excellent properties. The gloss of the coating, as measured by a BYK-Gardner gloss meter at a setting of 60 degrees, has been consistently measured at 75 or more gloss units. The coefficient of friction of the coating, as measured against itself, has been measured at 0.18. In addition, the coating exhibits excellent release characteristics, which are more fully explained below.

Once the EB curable coating has been applied, it is cured using a suitable electron beam source 26 to provide an EB cured coating 28 (FIG. 3). Suitable electron beam sources include apparatus that can be obtained commercially from Energy Science, Inc. of Wilmington, Mass. Such an apparatus is described in U.S. Pat. No. 6,426,507 to Rangwalla, et al., which is incorporated herein by reference.

The amount of energy absorbed during the curing process, also known as the dose, is measured in units of MegaRads (“MRads”) or kiloGrays (“kGy”), where one MRad is 10 kGy, one kGy being equal to 1,000 Joules per kilogram. The electron energy output should be within the range of 90 keV to 150 keV for a dosage of 2.0 to 4.0 MRads. Preferably, the energy is within the range of 115 keV to 125 keV for a dosage of 2.5 to 3.5 MRads, and most preferably 120 keV for a dosage of 3.0 MRads.

When exposed to an electron beam from a suitable source, monomer reacts with the oligomer chains to form cross-links. As already noted, the slip agent in the coating also react with and bond to the chains. The precursor molecules are excited directly by the ionizing electron beam. Therefore no photoinitiator compounds are required, so no residual volatile organic compounds are present in the finished product. Moreover, curing is substantially instantaneous and provides a cure percentage at or near one hundred percent.

It has been found that the electron beam curable coating of the present invention can be processed at manufacturing speeds in excess of 1000 feet per minute. Such processing speeds are a great improvement over typical lamination speeds which are about 600 feet per minute.

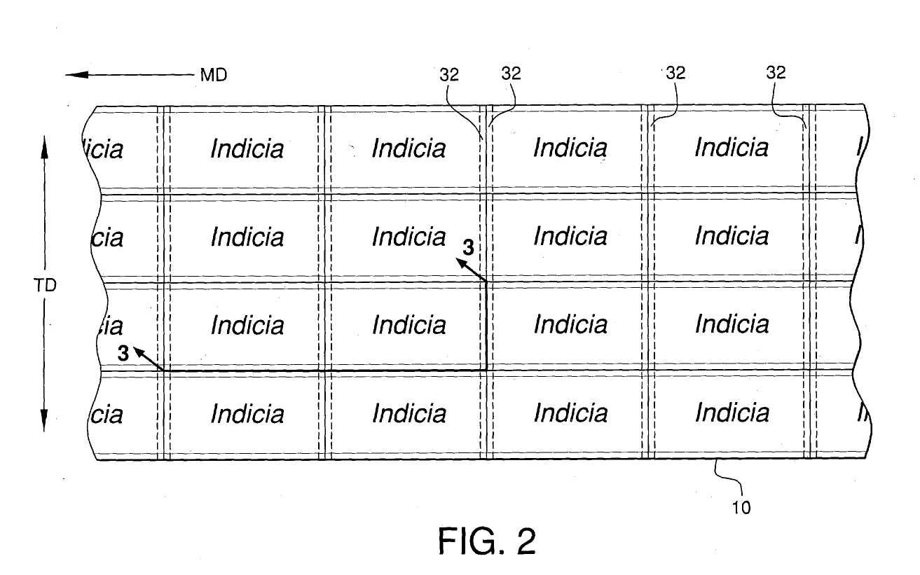

Once the coating has been cured at the EB source 26, the web 10 passes to a PSA application station 30. The PSA application station 30 can be a flexo graphic, roto gravure or other apparatus capable of pattern applying PSA. Labels can be made according to any producer's size specifications. However a label for a typical two-liter type bottle will be used by way of example. If such a bottle has a body circumference of about 34 cm, it is preferred that labels be produced with a width of 34 cm or less so that the edges of the label do not overlap when applied to the bottle. Such a label might have a height of about 13 cm. If the top to bottom orientation of the printed image of the labels being produced is in the transverse direction (i.e., transverse to the direction in which the web is moving), then the PSA is pattern applied in strips 32 also running in the transverse direction. The transverse direction and machine direction are identified as “TD” and “MD”, respectively, in FIG. 2. The distance between the centers of each successive strip can be slightly greater than the width of the labels to be produced in order to provide room for registration marks or other features required for later processing. If the labels are being produced with a printed image having a top to bottom orientation in the machine direction, then the PSA strips can instead be formed in the machine direction at distances from one another (center to center) of slightly greater than one label width.

Preferred PSA for use in the present invention is a PSA having a greater affinity for the substrate 14 than the EB cured coating 28. Thus, the PSA 32 will remain affixed to the substrate 14 once the PSA 32 contacts and releases from the EB cured coating 28 when the web 10 is wound in a roll and subsequently unwound. PSA with an average cling value of less than about 50 grams per inch, as measured by an IC block tester from Kohler Instruments, is suitable. If the selected PSA does not have greater affinity for the substrate 14 than the EB cured coating 28, than a tie layer could be used in between the PSA 32 and the substrate 14. The PSA also must have good affinity to the material forming the bottles to which the labels will be applied, such as PET. Suitable adhesives are solvent-based acrylic PSAs commercially available from Rohm & Haas.

Once the PSA 32 has been pattern applied at the PSA application station 30, the web is run through a dryer 34 in order to cure the adhesive and drive off any volatile solvents. It is preferred that the web 10 be produced with more than one label image in the transverse direction, as shown in FIG. 2. Thus, the web 10 is next run through a slitter 36 to cut the web 10 in the machine direction into narrower webs each having one image across and being of appropriate width to feed into a roll-fed labeling machine. If the web 10 has been printed with four images across (in the transverse direction), like that shown in FIG. 2, the slitter cuts the web 10 in the machine direction into four such webs 10A (only one web shown in FIG. 1), each of which is then taken up into a take-up roll 38. The number of images that can be printed across on a web 10 is limited by the height of the desired label and the width of the substrate that the production line can accommodate.

With the web 10 wound into one or more take up-rolls 38, the pattern applied PSA 32 contacts the EB cured coating 28 of the adjacent roll layer. Due to the pressure of roll-winding, the PSA 32 and EB cured coating 28 can be held together tightly while in the roll 38. However, the PSA 32 will not block due to the release properties of the EB cured coating 28. As described above, the slip agents in the EB cured coating 32 are reacted into the cross-linked oligomer/monomer network of the coating and are, therefore, non-migratory. Thus, the slip agents do not bloom out of the coating or adversely affect the adhesion of the PSA 32 to the substrate 14.

Once the take-up rolls 38 are completely formed, they can be shipped to a producer of an article to be labeled, such as a bottler. From the bottler's perspective, the take-up roll 38 received by the bottler is a supply roll. The bottler uses the take-up roll 38 in conjunction with an automated roll-fed labeling machine 40. Suitable labeling machines are sold by Krones, Inc. of Franklin, Wis. and Trine Labeling Systems of Fullerton, Calif. A Trine 6500 is one such suitable machine. Roll-fed labeling machines are described in U.S. Pat. No. 4,844,760 to Dickey, which is incorporated herein by reference. The bottler positions the roll 38 in association with the labeling machine 40 and feeds the leading edge of the web 10A through the machine 40. In operation, as the roll 38 is unwound, the PSA 32 does not block as it separates from the adjacent EB cured layer 28 in the roll, but instead remains in-tact and affixed to the substrate 14. As web 10A proceeds through the machine 40, the labeling machine 40 cuts the web 10A into the proper width of one label and, using pressure, applies the label to a bottle 42 moving along a conveyer belt 44. While practicing the method of the present invention, there is no need to apply hot melt adhesive to the label at the bottler's plant, thereby saving the bottler the cost of the adhesive and preventing the possibility of mis-registration of an adhesive applicator.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of labeling an article comprising:
coating a first side of a substrate with an electron beam curable coating comprising an oligomer, a monomer and a functional slip agent;
curing the coating with electron beam radiation to form a cross-linked oligomer/monomer network;
pattern applying pressure sensitive adhesive to a second side of the substrate;
winding the coated substrate into a roll;
unwinding at least a portion of the roll;
cutting the coated substrate into the shape of a label; and
applying the label to the article by affixing the PSA to the outside surface of the article and applying pressure.

2. The method of claim 1 wherein the curing step comprises the steps of ionizing a double bond in the functional slip agent and reacting the slip agent into the oligomer/monomer network.

3. The method of claim 1, further comprising the step of printing an image on the first side of the substrate prior to the coating step.

4. The method of claim 1 wherein the curing step comprises exposing the electron beam curable coating to an electron beam having energy of from about 90 keV to about 150 keV wherein the coating absorbs a dosage of from about 2.0 to about 4.0 MegaRads.

5. The method of claim 1 wherein the curing step comprises exposing the electron beam curable coating to an electron beam having energy of from about 115 keV to about 125 keV wherein the coating absorbs a dosage of from about 2.5 to about 3.5 MegaRads.

6. The method of claim 1 wherein the pattern applying step comprises coating strips of pressure sensitive adhesive running in the transverse direction at intervals corresponding to the length of labels to be produced.

7. The method of claim 1 further comprising the step of slitting the web in the machine direction prior to the winding step.

8. A method of producing a preprinted label comprising:
unwinding a web from a supply roll;
printing an image on a first side of the web using one or more printing stations;
coating an EB curable coating comprising at least one functional processing additive onto the first side of the web;
curing the EB curable coating with an electron beam to form a release coating comprising a stable cross-linked network, the curing including the step of ionizing the functional processing additive and reacting the processing additive into the network; and
pattern applying a pressure sensitive adhesive onto the second side of the substrate.

9. The method of claim 8 further comprising the step of winding the web into a roll.

10. The method of claim 9 further comprising the step of shipping the roll to a producer of articles to be labeled.

11. The method of claim 10 further comprising the steps of
unwinding the roll,
feeding the leading edge of the web into a roll-fed labeling machine; and
applying labels cut from the web to articles without applying adhesive to the web after the shipping step.

12. The method of claim 8 wherein the curing step comprises the step of ionizing a carbon double bond within a functional group of the processing additive.

13. The method of claim 12 wherein the step of ionizing the double bond comprises the step of breaking a carbon-carbon double bond.

14. The method of claim 12 wherein the curing step further comprises reacting the ionized carbon with the cross-linked network.

15. A method of producing, distributing and using labels of the type which are preprinted for use by a packager for a pre-selected article, the method comprising:
providing a printable continuous web;
moving the continuous web in-line
through one or more printing stations where an image is printed on the web,
through an electron beam curable coating station where an electron beam curable coating is applied to a first side of the web,
through an electron beam curing apparatus where the electron beam curable coating is irradiation cross-linked to provide a release coating comprising a stable network of oligomer, monomer and at least one functional processing additive, and
through a pressure sensitive adhesive application station where a pressure sensitive adhesive is pattern applied to a second side of the web;
winding the web into a roll;
shipping the roll to the packager; and
unwinding the roll, cutting the web into the size of labels and affixing the labels to the articles using an automated process without applying adhesive after the shipping step.

16. The method of claim 15 wherein irradiation cross-linking of the coating comprises the step of exposing the coating to electron beam radiation having energy of from about 115 keV to about 125 keV.

17. The method of claim 15 wherein irradiation cross-linking of the coating comprises the steps of breaking a carbon double bond in the functional processing additive and chemically bonding the processing additive with the oligomer/monomer network.
